(19) United States
(12) Patent Application Publication
(10) Pub. No.: US 2016/0311651 A1
(43) Pub. Date: Oct. 27, 2016

(54) PASSENGER CONVEYOR SYSTEM MONITORING DEVICE AND METHOD FOR INSTALLING THE SAME

(71) Applicant: OTIS ELEVATOR COMPANY, Farmington, CT (US)

(72) Inventor: Tony C. BLACK, South Windsor, CT (US)

(21) Appl. No.: 15/103,661

(22) PCT Filed: Dec. 12, 2013
(86) PCT No.: PCT/US2013/074719

§ 371 Date: Jun. 10, 2016

(51) Int. Cl. B66B 5/00; B66B 27/00; B66B 19/00

(52) U.S. Cl. CPC B66B 5/0025; B66B 19/00; B66B 27/00

(57) ABSTRACT

A monitoring device for use in a passenger conveyor system includes an indicator operable to indicate a need for a maintenance action in response to a control signal. Operation of the indicator relies on an electronic memory device. The electronic memory device is included in a separate component of the passenger conveyor system. A method for installing the monitoring device includes: (1) providing the monitoring device; (2) mounting the mounting device at a position within the passenger conveyor system such that the mounting device is easily accessible to a user; and (3) connecting the monitoring device to the separate component of the passenger conveyor system to permit communication there between.

### BACKGROUND

1. Technical Field

Aspects of the present invention relate to a monitoring device, and a method for installing the same. More particularly, as aspects of the present invention relate to a monitoring device for use in a passenger conveyor system, and a method for installing the same.

2. Background Information

A passenger conveyor system (e.g., an elevator system, an escalator system, a moving sidewalk system) can require various different maintenance actions (e.g., testing a safety characteristic of a component of the passenger conveyor system, maintaining or replacing a component of the passenger conveyor system). The need for a maintenance action can depend on a number of times that the passenger conveyor system, or a component thereof, has been operated since a previous maintenance action. The need for a maintenance action can additionally or alternatively depend on a calendar date and/or a length of time (e.g., a number of days, weeks, months, or years) that has passed since a previous maintenance action. It can be difficult for a maintenance provider to keep track of when various different maintenance actions are needed. Monitoring devices have been provided in an attempt to overcome this problem. Some monitoring devices include sophisticated complex automated computer and remote communication systems that require multiple levels of communication between the conveyor system and the local mechanic. These monitoring devices can be expensive, they can be difficult to operate without intensive training, and/or they can be impossible to install on older equipment or systems for which the electronic communication protocol is unknown. Aspects of the present invention are directed to these and other problems.

### SUMMARY OF ASPECTS OF THE INVENTION

According to an aspect of the present invention, a monitoring device for use in a passenger conveyor system is provided. The monitoring device includes an indicator operable to indicate a need for a maintenance action in response to a control signal. Operation of the indicator relies on an electronic memory device. The electronic memory device is included in a separate component of the passenger conveyor system.

According to another aspect of the present invention, a method of installing a monitoring device in a passenger conveyor system is provided. The method includes the steps of: (1) providing the monitoring device, wherein the monitoring device includes an indicator operable to indicate a need for a maintenance action in response to a control signal, and wherein operation of the indicator relies on an electronic memory device that is included in a separate component of the passenger conveyor system; (2) mounting the mounting device at a position within the passenger conveyor system such that the mounting device is easily accessible to a user; and (3) connecting the monitoring device to the separate component of the passenger conveyor system to permit communication there between.

Additionally or alternatively, the present invention may include one or more of the following features individually or in combination:
the passenger conveyor system is an elevator system, an escalator system, or a moving sidewalk system;
the indicator is operable to indicate the need for the maintenance action directly to a user;
the control signal is indicative of a number of times an event has occurred in the passenger conveyor system;
the indicator indicates the need for the maintenance action when the control signal indicates that the number of times the event has occurred has reached a predetermined limit;
the event is an operation of a component of the passenger conveyor system;
the control signal is indicative of a calendar date;
the indicator indicates the need for the maintenance action when the control signal indicates that the calendar date has reached a predetermined calendar date;
the control signal is indicative of a time lapse that has occurred since a previous maintenance action;
the indicator indicates the need for the maintenance action when the control signal indicates that the time lapse has reached a predetermined limit;
the maintenance action involves testing a safety characteristic of a component of the passenger conveyor system, replacing a component of the passenger conveyor system, repairing a component of the passenger conveyor system, and/or cleaning a component of the passenger conveyor system;
the control signal is generated by a controller;
the controller includes a digital counter;
the controller includes an analog counter;
the controller is separate from the monitoring device;
the electronic memory device is included in the controller;
the indicator includes a flag operable to be actuated from a first position to a second position to visually indicate to a user the need for the maintenance action, wherein the indicator is in a non-indicating state when the flag is in the first position and the indicator is in an indicating state when the flag is in the second position;
the indicator includes a light source operable to be actuated between a power-off state to a power-on state to visually indicate to a user the need for the maintenance action, wherein the indicator is in a non-indicating state when the light source is in the power-off state and the indicator is in an indicating state when the light source is in the power-on state;
the indicator includes a sound source operable to be actuated between a power-off state to a power-on state to audibly indicate to a user the need for the maintenance action, wherein the indicator is in a non-indicating state when the sound source is in the power-off state and the indicator is in an indicating state when the sound source is in the power-on state;
the indicator includes a reset feature operable to permit a user to return the indicator from an indicating state to a non-indicating state;
the indicator includes a locking feature operable to receive an input from a user, and wherein the locking feature permits the indicator to be returned from an indicating state to a non-indicating state only after the input has been received;
the indicator includes a transmitting feature operable to enable the indicator to indicate a need for a maintenance action indirectly to a user;
the indicator is a first indicator operable to indicate a need for a first maintenance action in response to a first control signal, and wherein the monitoring device further comprises a second indicator operable to indicate a need for a second maintenance action in response to the first control signal;
the indicator is a first indicator operable to indicate a need for a first maintenance action in response to a first control signal, and wherein the monitoring device further comprises a second indicator operable to indicate a need for a second maintenance action in response to a second control signal;
the passenger conveyor system includes a landing, and wherein the monitoring device is disposed relative to the landing;
the passenger conveyor system includes a machine room, and wherein the monitoring device is disposed within the machine room;
the passenger conveyor system includes a passenger conveyor, and wherein the monitoring device is disposed relative to the passenger conveyor; and
the passenger conveyor system is an elevator system and the passenger conveyor is an elevator car.

These and other aspects of the present invention will become apparent in light of the drawings and detailed description provided below.

### BRIEF DESCRIPTION OF THE DRAWINGS

FIG. 1 illustrates a schematic elevation view of a passenger conveyor system that includes an embodiment of the monitoring device.

FIG. 2 illustrates a schematic perspective view of the monitoring device of FIG. 1.

FIG. 3 illustrates a schematic perspective view of the monitoring device of FIG. 1.

### DETAILED DESCRIPTION OF ASPECTS OF THE INVENTION

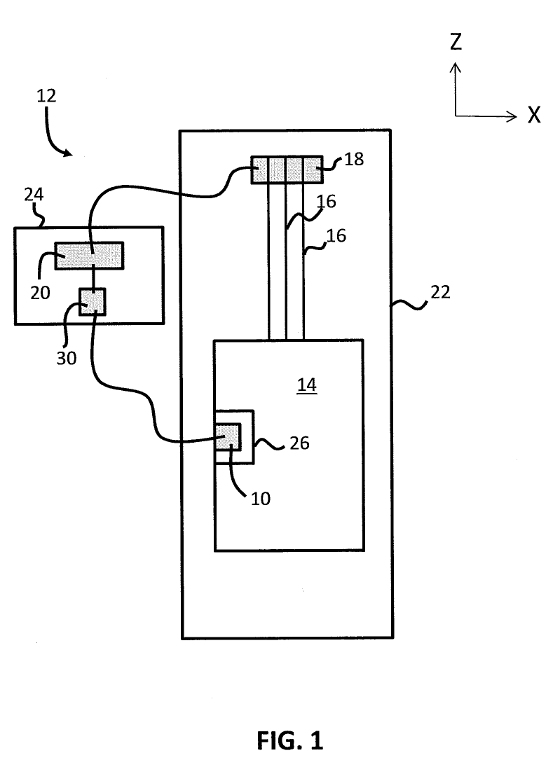

Referring to FIG. 1, the present disclosure describes embodiments of a monitoring device 10 for use in a passenger conveyor system 12, and methods for installing the same. The present disclosure describes aspects of the present invention with reference to the exemplary embodiment illustrated in the drawings; however, aspects of the present invention are not limited to the exemplary embodiment illustrated in the drawings. The present disclosure may describe a feature as having a length extending relative to a x-axis, a width extending relative to a y-axis, and/or a height extending relative to a z-axis. The drawings illustrate the respective axes.

The monitoring device 10 is operable for use in various types of passenger conveyor systems 12 (e.g., elevator systems, escalator systems, moving sidewalk systems). In the illustrated embodiment, the passenger conveyor system 12 is an elevator system. For ease of description, the passenger conveyor system 12 will hereinafter be referred to as the “elevator system 12”.

The elevator system 12 can be configured in various different ways. In the illustrated embodiment, the elevator system 12 includes an elevator car 14 connected to a counterweight (not shown) by a plurality of tension members 16. The tension members 16 contact a sheave 18 that is operable to be driven by a machine 20 to move the elevator car 14 and the counterweight within the hoistway 22. The machine 20 is disposed within a machine room 24. The machine room 24 is disposed proximate the hoistway 22.

The monitoring device 10 is positioned within the elevator system 12 such that it is relatively easily accessible to a user (e.g., a maintenance provider, a passenger). In the illustrated embodiment, for example, the monitoring device 10 is enclosed within a housing 26 that is mounted to an inner surface of a wall of the elevator car 14. The housing 26 is operable to be locked so that the monitoring device 10 is accessible to authorized users (e.g., maintenance providers), but is not accessible to unauthorized users (e.g., passengers). In some embodiments, the monitoring device 10 can be positioned proximate a location (e.g., a landing) where passengers enter the elevator system 12, a location (e.g., a machine room) where a maintenance provider typically performs a maintenance action, or another location. In some embodiments, the monitoring device 10 can be integrated with a passenger interface device (e.g., a keypad device, a touchscreen device).

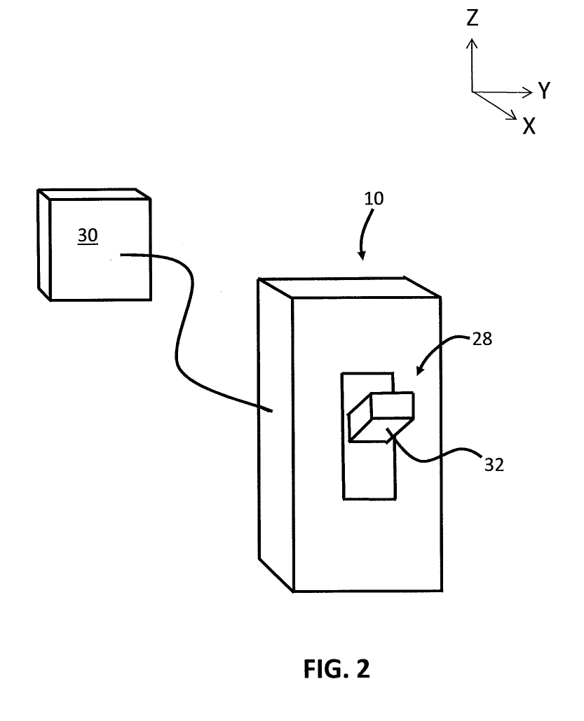

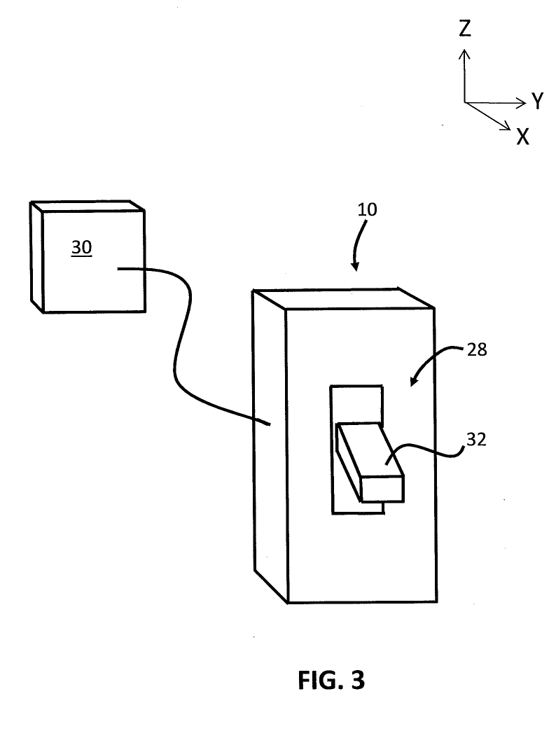

Referring to FIGS. 2 and 3, the monitoring device 10 is operable to receive a control signal, and the monitoring device 10 includes at least one indicator 28 that is operable to indicate a need for a maintenance action in response to the control signal.

The control signal can communicate various different information to the indicator 28. In the illustrated embodiment, for example, the control signal can be indicative of a number of times an event has occurred in the elevator system 12 (e.g., a number of times the elevator system 12, or a component thereof, has been operated). The control signal can additionally or alternatively be indicative of a calendar date (e.g., a calendar date having a day, a month, and a year), and/or a time lapse that has occurred since a previous maintenance action.

The control signal is generated (e.g., periodically generated, continuously generated) by at least one component of the elevator system 12. In the illustrated embodiment, the control signal is generated by a controller 30.

In some embodiments, the component that generates the control signal (e.g., the controller 30) is separate from the monitoring device 10. In the illustrated embodiment, for example, the controller 30 is disposed within the machine room 24 (see FIG. 1), while the monitoring device 10 is disposed within the elevator car 14 (see FIG. 1) as described above. In other embodiments, the component, or one or more features thereof, can be implemented as a feature of the monitoring device 10.

The component that generates the control signal (e.g., the controller 30) can be implemented in various different ways. In some embodiments, the component can be implemented using analog and/or digital hardware (e.g., counters, switches, logic devices, memory devices, programmable processors, non-transitory computer readable storage mediums), software, firmware, or a combination thereof. The component can perform one or more of the functions described herein by executing software, which can be stored, for example, in a memory device included in the component. A person having ordinary skill in the art would be able to adapt (e.g., construct, program) the component to perform the functionality described herein without undue experimentation. In the illustrated embodiment, the controller 30 includes a known analog counter. The analog counter is operable to determine: (1) a number of times an event has occurred in the elevator system 12; (2) a calendar date; and (3) a time lapse that has occurred since a previous maintenance action.

In some embodiments, the component that generates the control signal (e.g., the controller 30) can be a component that would be included in the elevator system 12 even in the absence of the monitoring device 10. This feature of the monitoring device 10 can be advantageous in that the monitoring device 10 can make use of existing components and can thereby eliminate significant cost and/or labor that might be required if an additional component were provided to generate the control signal. In the illustrated embodiment, the primary function of the controller 30 is to control the machine 20 that drives the sheave 18 (see FIG. 1), and thus the controller 30 would be included in the elevator system 12 even in the absence of the monitoring device 10.

The indicator 28 can function in various different ways. In the illustrated embodiment, for example, the indicator 28 can indicate a need for a maintenance action when the control signal indicates that the number of times the event has occurred has reached a predetermined limit; the indicator 28 can indicate a need for a maintenance action when the control signal indicates that the calendar date has reached a predetermined calendar date; and the indicator 28 can indicate a need for a maintenance action when the control signal indicates that a time lapse that has occurred since a previous maintenance action has reached a predetermined limit. In the illustrated embodiment, the indicator 28 can visually indicate a need for a maintenance action directly to a user. In other embodiments, the indicator 28 can audibly indicate a need for a maintenance action to a user, and/or the indicator 28 can indicate a need for a maintenance action indirectly to a user (e.g., via a transmitting feature, as will be described below).

The indicator 28 can be implemented in various different ways. For example, the indicator 28 can be implemented using electrical and/or mechanical features. In the illustrated embodiment, the indicator 28 includes a flag 32 that is operable to be actuated by the control signal, from a first position (see FIG. 2) to a second position (see FIG. 3), to visually indicate to a user a need for a maintenance action. The indicator 28 is in a non-indicating state when the flag 32 is in the first position (see FIG. 2), and is in an indicating state when the flag 32 is in the second position (see FIG. 3). In another embodiment not illustrated in the drawings, the indicator 28 includes a light source (e.g., an LED) that is operable to be actuated by the control signal, between a power-off state and a power-on state, to visually indicate to a user a need for a maintenance action. The indicator 28 is in a non-indicating state when the light source is in the power-off state, and is in an indicating state when the light source is in the power-on state. In another embodiment not illustrated in the drawings, the indicator 28 includes a sound source (e.g., an amplifier and a speaker) that is operable to be actuated by the control signal, between a power-off state and a power-on state, to audibly indicate to a user a need for a maintenance action. The indicator 28 is in a non-indicating state when the sound source is in the power-off state, and is in an indicating state when the sound source is in the power-on state.

The monitoring device 10 does not include an electronic memory device (e.g., a random access memory (RAM) device). Instead, the monitoring device 10 relies on an electronic memory device included in a separate (e.g., physically separate) component of the elevator system 12. For example, the monitoring device 10 can rely on an electronic memory device included in the component (e.g., the controller 30) that generates the control signal. This feature of the monitoring device 10 can be advantageous in that the monitoring device 10 makes use of an existing electronic memory device and can thereby eliminate significant cost and/or labor that might be required if an additional electronic memory device were included in the monitoring device 10.

In some embodiments, the monitoring device 10 can include one or more labels (not shown) disposed proximate the indicator 28. The labels can inform a user that the non-indicating state means that there is no need for a maintenance action, and that the indicating state means that there is a need for a maintenance action.

The indicator 28 can indicate a need for various different maintenance actions. In some embodiments, for example, the maintenance action can include testing a safety characteristic of a component of the elevator system 12, replacing a component of the elevator system 12, repairing a component of the elevator system 12, and/or cleaning a component of the elevator system 12. The above-described labels can be provided to inform a user as to which maintenance action the indicator 28 corresponds to.

In some embodiments not shown in the drawings, the monitoring device 10 can include more than one indicator 28. The indicators 28 can indicate needs for one or more maintenance actions in response to one or more control signals. The control signals can be generated by one or more components of the elevator system 12 (e.g., one or more controllers 30). For example, in one embodiment not illustrated in the drawings, the monitoring device 10 includes a first indicator 28 that is operable to indicate a need for a first maintenance action (e.g., testing a safety characteristic of a component of the elevator system 12) in response to a first control signal generated by a first controller 30, and a second indicator 28 that is operable to indicate a need for a second maintenance action (e.g., replacing a component of the elevator system 12) in response to a second control signal generated by a second controller 30. The monitoring device 10 includes a first label disposed proximate the first indicator 28 to inform a user that the first indicator 28 corresponds to the first maintenance action, and a second label disposed proximate the second indicator 28 to inform a user that the second indicator 28 corresponds to the second maintenance action.

In some embodiments, the monitoring device 10 includes a reset feature that permits a user to return the indicator 28 from an indicating state to a non-indicating state. In the illustrated embodiment, for example, the flag 32 is operable to be moved from the second position (see FIG. 3) to the first position (see FIG. 2) by a user.

In some embodiments in which the monitoring device 10 includes a reset feature, the monitoring device 10 additionally includes a locking feature that is operable to receive an input (e.g., a mechanical key, an electronic password) from a user. The locking feature permits the indicator 28 to be returned from an indicating state to a non-indicating state only after the input has been received. The reset feature can be implemented in various different ways. For example, the reset feature can be implemented using electrical and/or mechanical features or could be implemented using a separate communication device (e.g., a mobile communication device, a handheld electronic device) to communicate with the monitoring device. A person having ordinary skill in the art would be able to adapt the reset feature to perform the functionality described herein without undue experimentation.

In some embodiments, the monitoring device 10 includes a transmitting feature that enables the indicator 28 to indicate a need for a maintenance action indirectly to a user (e.g., to a user located at a remote position relative to the monitoring device 10). For example, the transmitting feature can transmit information provided by the indicator 28 to a remote device using one or more wired and/or wireless connections. The transmitting feature can be implemented in various different ways, and can include one or more known transmitting technologies. A person having ordinary skill in the art would be able to adapt the transmitting feature to perform the functionality described herein without undue experimentation.

The monitoring device 10 can be installed in the elevator system 12 in various different ways. In one embodiment, a method for installing the monitoring device 10 includes the steps of: (1) providing the monitoring device 10; (2) mounting the mounting device 10 at a position within the elevator system 12 such that the mounting device 10 is relatively easily accessible to a user, as described above; and (3) connecting the monitoring device 10 to the component (e.g., the controller 30) of the elevator system 12 that includes the electronic memory device to permit communication there between, as described above.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A monitoring device for use in a passenger conveyor system, the monitoring device comprising:
an indicator operable to indicate a need for a maintenance action in response to a control signal;
wherein operation of the indicator relies on an electronic memory device, and wherein the electronic memory device is included in a separate component of the passenger conveyor system.

2. The monitoring device of claim 1, wherein the passenger conveyor system is an elevator system, an escalator system, or a moving sidewalk system.

3. The monitoring device of claim 1, wherein the indicator is operable to indicate the need for the maintenance action directly to a user.

4. The monitoring device of claim 1, wherein the control signal is indicative of a number of times an event has occurred in the passenger conveyor system.

5. The monitoring device of claim 4, wherein the indicator indicates the need for the maintenance action when the control signal indicates that the number of times the event has occurred has reached a predetermined limit.

6. The monitoring device of claim 5, wherein the event is an operation of a component of the passenger conveyor system.

7. The monitoring device of claim 1, wherein the control signal is indicative of a calendar date.

8. The monitoring device of claim 7, wherein the indicator indicates the need for the maintenance action when the control signal indicates that the calendar date has reached a predetermined calendar date.

9. The monitoring device of claim 1, wherein the control signal is indicative of a time lapse that has occurred since a previous maintenance action.

10. The monitoring device of claim 9, wherein the indicator indicates the need for the maintenance action when the control signal indicates that the time lapse has reached a predetermined limit.

11. The monitoring device of claim 1, wherein the maintenance action involves testing a safety characteristic of a component of the passenger conveyor system, replacing a component of the passenger conveyor system, repairing a component of the passenger conveyor system, and/or cleaning a component of the passenger conveyor system.

12. The monitoring device of claim 1, wherein the control signal is generated by a controller.

13. The monitoring device of claim 12, wherein the controller includes a digital counter.

14. The monitoring device of claim 12, wherein the controller includes an analog counter.

15. The monitoring device of claim 12, wherein the controller is separate from the monitoring device.

16. The monitoring device of claim 12, wherein the electronic memory device is included in the controller.

17. The monitoring device of claim 1, wherein the indicator includes a flag operable to be actuated from a first position to a second position to visually indicate to a user the need for the maintenance action, wherein the indicator is in a non-indicating state when the flag is in the first position and the indicator is in an indicating state when the flag is in the second position.

18. The monitoring device of claim 1, wherein the indicator includes a light source operable to be actuated between a power-off state to a power-on state to visually indicate to a user the need for the maintenance action, wherein the indicator is in a non-indicating state when the light source is in the power-off state and the indicator is in an indicating state when the light source is in the power-on state.

19. The monitoring device of claim 1, wherein the indicator includes a sound source operable to be actuated between a power-off state to a power-on state to audibly indicate to a user the need for the maintenance action, wherein the indicator is in a non-indicating state when the sound source is in the power-off state and the indicator is in an indicating state when the sound source is in the power-on state.

20. The monitoring device of claim 1, wherein the indicator includes a reset feature operable to permit a user to return the indicator from an indicating state to a non-indicating state.

21. The monitoring device of claim 1, wherein the indicator includes a locking feature operable to receive an input from a user, and wherein the locking feature permits the indicator to be returned from an indicating state to a non-indicating state only after the input has been received.

22. The monitoring device of claim 1, wherein the indicator includes a transmitting feature operable to enable the indicator to indicate a need for a maintenance action indirectly to a user.

23. The monitoring device of claim 1, wherein the indicator is a first indicator operable to indicate a need for a first maintenance action in response to a first control signal, and wherein the monitoring device further comprises a second indicator operable to indicate a need for a second maintenance action in response to the first control signal.

24. The monitoring device of claim 1, wherein the indicator is a first indicator operable to indicate a need for a first maintenance action in response to a first control signal, and wherein the monitoring device further comprises a second indicator operable to indicate a need for a second maintenance action in response to a second control signal.

25. The monitoring device of claim 1, wherein the passenger conveyor system includes a landing, and wherein the monitoring device is disposed relative to the landing.

26. The monitoring device of claim 1, wherein the passenger conveyor system includes a machine room, and wherein the monitoring device is disposed within the machine room.

27. The monitoring device of claim 1, wherein the passenger conveyor system includes a passenger conveyor, and wherein the monitoring device is disposed relative to the passenger conveyor.

28. The monitoring device of claim 1, wherein the passenger conveyor system is an elevator system and the passenger conveyor is an elevator car.

29. A method of installing a monitoring device in a passenger conveyor system, comprising:
providing the monitoring device, wherein the monitoring device includes an indicator operable to indicate a need for a maintenance action in response to a control signal, and wherein operation of the indicator relies on an electronic memory device that is included in a separate component of the passenger conveyor system;
mounting the mounting device at a position within the passenger conveyor system such that the mounting device is easily accessible to a user;
connecting the monitoring device to the separate component of the passenger conveyor system to permit communication there between.

30. The method of claim 29, wherein the position is such that the mounting device is accessible to an authorized user and is inaccessible to an unauthorized user.

31. The method of claim 29, wherein the passenger conveyor system includes a landing, and wherein the position is proximate the landing.

32. The method of claim 29, wherein the passenger conveyor system includes a machine room, and wherein position is within the machine room.

33. The method of claim 29, wherein the passenger conveyor system includes a passenger conveyor, and wherein the position is within the passenger conveyor.
